(19) United States
(12) Patent Application Publication
(10) Pub. No.: US 2012/0241994 A1
(43) Pub. Date: Sep. 27, 2012

(54) SYNTHETIC CORK WITH A NATURAL CORK APPEARANCE AND METHOD OF MAKING IT

(75) Inventors: Alberto Baban, Venezia (IT); Miguel Escobar, Mexico D.F. (MX)

(73) Assignee: TAPI NORTH AMERICA S.A. DE C.V., Mexico City (MX)

(21) Appl. No.: 13/491,819

(22) Filed: Jun. 8, 2012

Related U.S. Application Data
(62) Division of application No. 11/640,999, filed on Dec. 19, 2006.
(60) Provisional application No. 60/751,299, filed on Dec. 19, 2005.

(51) Int. Cl. B29C 41/22; B28B 13/02; B29C 33/38

(52) U.S. Cl. 264/73; 264/219; 425/447

(57) ABSTRACT

A method of producing random and irregular markings and impressions on synthetic cork stoppers so as to closely mimic the surface texture of natural cork, and the stoppers produced thereby.-In one embodiment, the stopper is produced in a mold featuring a textured inner surface. In another embodiment, the stopper is extruded.

### CROSS REFERENCE TO RELATED APPLICATIONS

This application is a Divisional Application of and claims priority to U.S. patent application Ser. No. 11/640,999 filed Dec. 19, 2006; which claims priority to and the benefit of U.S. Provisional Patent Application Ser. No. 60/751,299 filed Dec. 19, 2005, both of which are fully incorporated herein by reference.

### FIELD OF INVENTION

This invention relates to the field of container closures commonly utilizing natural or basic synthetic cork.

### BACKGROUND OF THE INVENTION

Producers of wine and other products that are sold in bottles or other containers that are traditionally closed and sealed with cork stoppers have long been concerned about contamination of the cork, which can lead to spoilage of the product within the container. In the case of wine or olive oil, for example, such spoilage is immediately noticeable by the consumer and renders the product unfit for consumption.

For that reason, there has been a movement in recent times toward the use of synthetic stoppers in place of cork. The material used in the synthetic stopper will depend on the characteristics of the container's contents. If the synthetic materials used are non-reactive with the contents of the container, the synthetic stopper is a complete solution to the problem of contamination of the cork, and consequently the contents of the container.

However, penetration of synthetic stoppers into the food and wine container industry has been slow. Many producers of food and wine are reluctant to switch from traditional corks to synthetic stoppers for purely aesthetic reasons. Cork has a distinctive color and appearance in that it is rarely smooth, but rather is pockmarked with dark spots and often covered with pits and small voids in the surface of cut cork. Synthetic cork products have been produced to approximate the color, but not the physical appearance, of natural cork. Attempts have been made to create a synthetic stopper that realistically imitates natural cork. U.S. Pat. No. 4,363,849 (Paisley et al.) discloses an injection molding process wherein “coils” of synthetic material are injected into a mold; the boundaries between the “coils” create random lines in the stopper surface. U.S. Pat. No. 4,507,405 (Paisley et al.) discloses that these coils may be injected along with a colorant to accentuate the boundary lines. U.S. Pat. No. 4,522,856 (Paisley et al.) discloses a method of coloring the synthetic stopper to appear more like natural cork. However, these references disclose only methods of effectively “drawing” a cork-like appearance on the stopper surface in two dimensions. In order to gain wider acceptance, a need exists for synthetic stoppers with textured surfaces that appear more like the natural cork to which people are accustomed.

### SUMMARY OF INVENTION

In order to more accurately simulate the appearance of natural cork, the appearance of the exterior surface of the synthetic stopper should feature random and irregular holes, markings, or dimples. The surface may also feature color variations as found in natural cork. Viewed broadly, the invention provides a method of producing random and irregular holes, markings, and dimples on the surface of a synthetic stopper. The invention includes, in another aspect, the stopper made to appear as if it was formed of natural cork.

### BRIEF DESCRIPTION OF THE DRAWINGS

FIG. 1 is a side elevation view of a stopper made by a method in accordance with an exemplary embodiment of the present invention.

FIG. 2 is a plan view of a mold for making a stopper by a method in accordance with an exemplary embodiment of the present invention.

FIG. 3 is a side elevation view of a possible embodiment of an extrusion apparatus for making a stopper by a method in accordance with an exemplary embodiment of the present invention.

FIG. 4 is a front section view along Line 4 of the apparatus shown in FIG. 3.

FIG. 5 is a side elevation view of a second possible embodiment of an extrusion apparatus for making a stopper by a method in accordance with an exemplary embodiment of the present invention.

FIG. 6 is a front section view along Line 6 of the apparatus shown in FIG. 5.

### DETAILED DESCRIPTION

Methods of creating the random and irregular markings of the present invention include molding the details directly into the surface of the stopper and extruding the synthetic material into a desired shape before passing it through forming cylinders or rollers that contain the negative of the desired surface texture, and which imprint the texture onto the material's exterior surface.

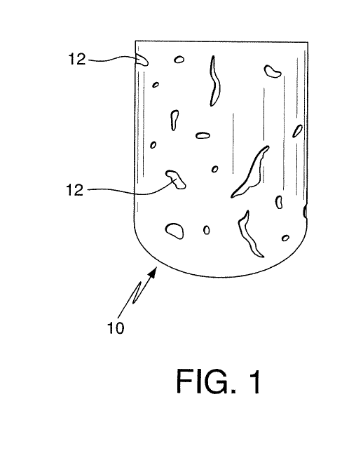

FIG. 1 shows a side elevation view of a stopper 10 made by a method in accordance with an exemplary embodiment of the present invention. Stopper 10 features random and irregular holes, markings, and dimples 12 on its outer surface. It will be obvious to one of ordinary skill in the art that the exact outer shape of stopper 10 is not limited to the shape depicted in FIG. 1; a number of methods of shaping a stopper are well-known in the art. Accordingly, the shape depicted in FIG. 1 should not be construed as limiting the present invention.

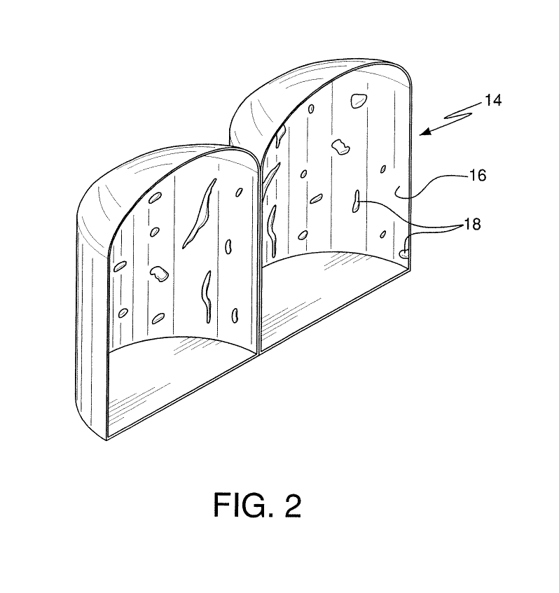

FIG. 2 shows a mold 14 used in a method in accordance with an exemplary embodiment of the present invention. Mold 14 includes interior surface 16, which features randomly-placed and irregularly-shaped contours, bumps, and ridges 18. When a suitable soft synthetic material is introduced into mold 14 and the mold is closed, bumps and ridges 18 create markings and dimples 12 in the outer surface of the synthetic material. As the material hardens, markings and dimples 12 become permanently impressed in the outer surface of the material, forming stopper 10. Though FIG. 2 depicts a mold for a single stopper according to the invention, it will be understood that such molds could be arranged in large groups to be filled and cooled simultaneously for mass production of the stoppers, or, alternatively, could have a one-piece construction.

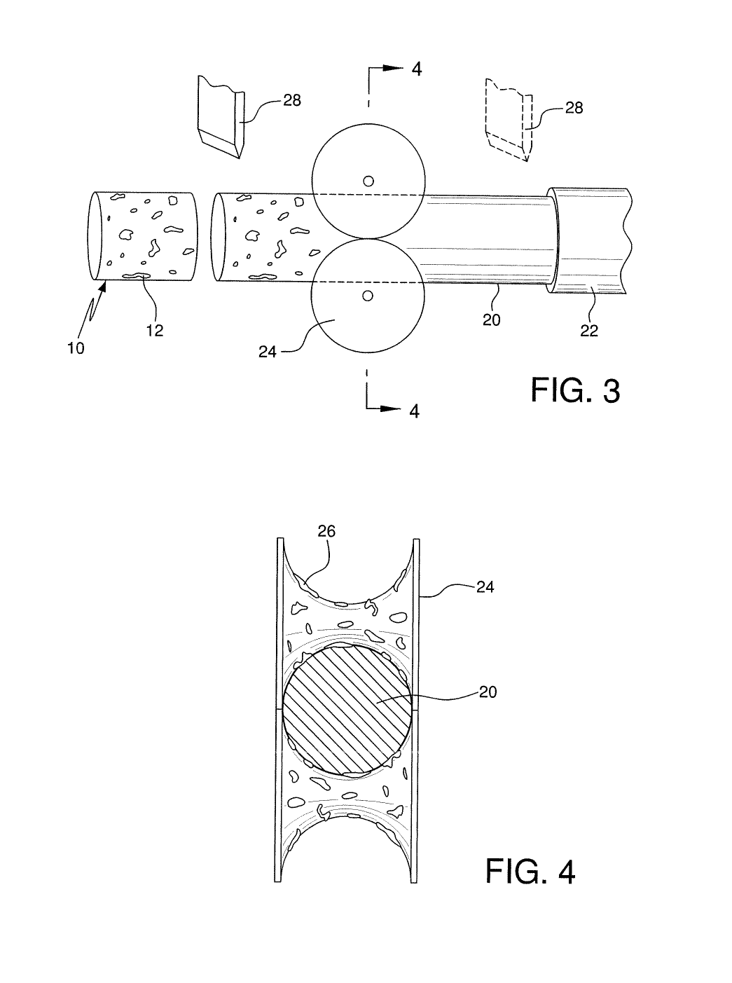

FIGS. 3-6 depict exemplary embodiments of an alternative method of the invention. In FIG. 3, synthetic material 20 is extruded through extrusion tube 22. Material 20 exits tube 22 with a smooth outer surface, and proceeds through impressing rollers 24. Rollers 24 are preferably shaped so as to contact substantially all of the outer surface of material 20, and feature on their contacting surfaces ridges and bumps 26. The ridges and bumps 26 create impressions and markings 12 in the exterior surface of the material 20. As depicted, material 20 may be cut into individual stoppers 10 either before or preferably after the impressing step by cutting means 28. FIG. 4 depicts the rollers 24 of FIG. 3 as seen along the direction of Line 4. Depending on the nature of the chosen material, cooling means (not shown) may be employed in the process to ensure that the impressions and markings are rendered permanent on the material surface.

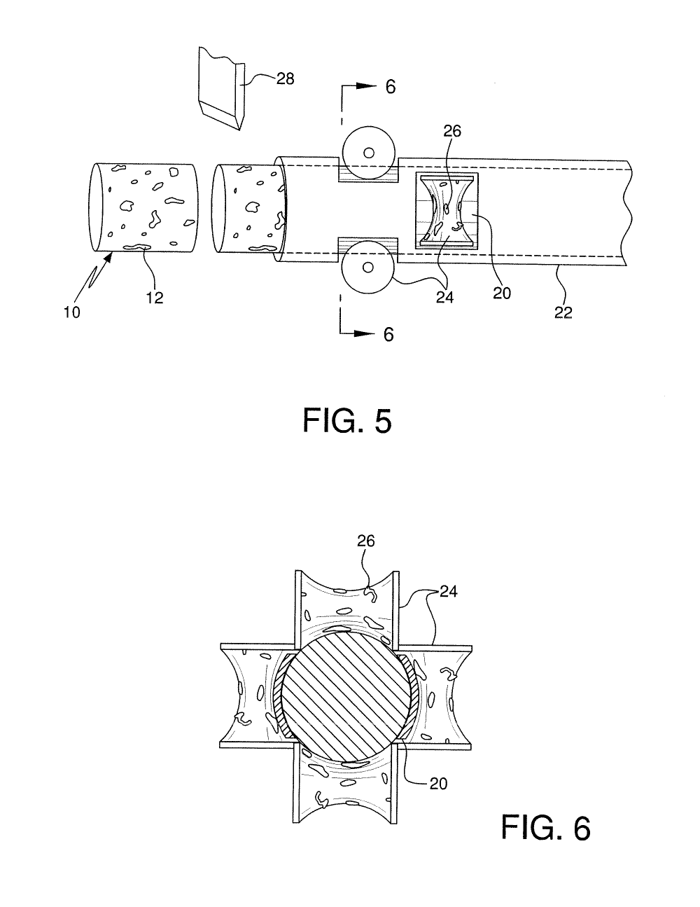

FIGS. 5-6 depict an alternative exemplary embodiment of the extrusion process shown in FIGS. 3-4. In FIG. 5, rollers 24 are integral with tube 22. FIG. 6 shows a view of the apparatus of FIG. 5 along Line 6.

It should be clear to persons skilled in the art that the cross-sectional shape of material 20 (and thus stopper 10) is not limited to a circle, and that rollers 24 may likewise be shaped to conform to the desired final cross-sectional shape of stopper 10. Although molding and extrusion are discussed herein, other methods of forming synthetic stoppers are known in the art. Likewise, while the impressing step is preferably performed by rollers, it may also be performed by other means; as used in this invention, “impressing” includes 3-dimensional detailing of the stopper surface by any means. The desired impressions could be stamped into the extruded soft synthetic material by stamps preferably shaped so as to contact substantially all of the material's exterior surface. The impressions could be cut by blades into the surface of the material, either before or after it hardens. The material also may be routed through the impressing step in any orientation, and need not be processed individually. For example, individual stoppers could be arranged in a layer, and impressed in batches.

Synthetic material suitable for use in stoppers is well-known in the art. Suitable materials include hot resin in either compact form or expanded via foaming/expanding agents. The guiding characteristics for selecting a material are non-reactivity with the expected container contents and softness, determined by compressibility and recuperation. Roughness is not necessarily a limitation, as it will depend on the individual application. Any color may be used, but will preferably mimic natural cork. The color also may or may not include dark points as found in natural cork.

The preferred embodiments of the present invention are used to store wine; however, use of the stoppers as described is not limited to wine, or even food; the stoppers may be used any container where use of a compressible, non-reactive stopper is desirable.

What is claimed is:

1. A method of producing random and irregular markings on synthetic stoppers, comprising:
forming a mold having on its inner surface randomly arranged contours, bumps, and ridges;
introducing a soft synthetic material into the mold, so as to impress the contours, bumps, and ridges into the surface of the synthetic material to form desired holes, markings, and dimples in the synthetic material, the resulting holes, markings, and dimples being the negative of the contours, bumps, and ridges;
allowing the synthetic material to harden so as to render the impressed holes, markings, and dimples permanent on the exterior surface of the synthetic material.

2. A method of forming a synthetic stopper, comprising:
forming a mold having on its inner surface randomly arranged surface contours;
introducing a soft synthetic material into the mold, so as to impress surface defects into the synthetic material to form desired surface defects in the synthetic material, the resulting surface defects being the negative of the surface contours of the mold;
allowing the synthetic material to harden so as to render the impressed surface defects permanent on the exterior surface of the synthetic material.

3. A method in accordance with claim 2, wherein said impressed surface defects approximate random defects found in natural cork stoppers.

4. A method in accordance with claim 3, wherein the surface of said synthetic stopper only includes surface contouring approximate to surface contouring of natural cork stoppers.

5. A method in accordance with claim 2, wherein said synthetic material is a compact or expanded hot resin.

6. A method in accordance with claim 2, wherein said synthetic material comprises a color approximate to natural cork coloring.

7. A method in accordance with claim 6, wherein said synthetic material color includes dark points approximate to dark points in natural cork coloring.

8. A method in accordance with claim 2, wherein said synthetic stopper has at least one curved or non-linear surface feature.

9. A method in accordance with claim 8 wherein said stopper includes said surface defects on at least a portion of said curved or non-linear surface feature.

10. A mold configured to generate a synthetic stopper having defects approximating natural cork, comprising:
an interior cavity having dimensions corresponding to the shape of a synthetic stopper, wherein the cavity interior includes defects thereon approximating the negative of defects found on natural cork; and
an inlet for configured to channel unhardened synthetic material to the interior cavity for hardening.
